(19) United States
(12) Patent Application Publication
(10) Pub. No.: US 2003/0112729 A1
(43) Pub. Date: Jun. 19, 2003

(54) System and method for identifying media

(76) Inventors: James B. Nichols, Paris (FR); David Clifford, San Jose, CA (US); James A. Crammond, Palo Alto, CA (US)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/025,248

(22) Filed: Dec. 17, 2001

(51) Int. Cl. G11B 7/00

(52) U.S. Cl. 369/53.22

(57) ABSTRACT

A system and method for identifying CDs is described. In one embodiment, the track offsets stored on the CD are used to perform a database lookup. A hash function such as an MD5 hash may be applied to the track offsets to generate an identification code. In the event that another CD has the same set of track offsets, an extension code may be generated using one or more secondary identification techniques. One identification technique which may be employed is an identification code generated based on a spectral analysis of the audio content stored on a portion of the CD. The identification code based on the spectral analysis may be used as either a primary identification code or a secondary identification code (i.e., the extension code).

### BACKGROUND

1. Field of the Invention

This invention relates generally to the field of media identification techniques. More particularly, the invention relates to an improved system and method for identifying digital storage media such as compact disks.

2. Description of the Related Art

Techniques for identifying digital storage media such as compact disks (“CDs”) and digital video disks (“DVDs”) have been around for some time. For example, Yankowski, U.S. Pat. No. 5,751,672 (hereinafter “Yankowski”), discloses techniques for calculating a unique “fingerprint” for a CD. The “fingerprint” may be based on the table of contents (“TOC”) for the CD which contains “the number of movements, the play time of each movement (or, e.g., the playtime of the first five movements) and the total play time of the CD.” Column 6, lines 12-14. In addition, Yankowski mentions that “a sample of the actual disk data representing a musical selection or movement can also be used to uniquely identify each disk.” Column 6, lines 26-28. One specific technique disclosed by Yankowski is that “several data samples taken at consistent locations on a disk can also be statistically likely to uniquely identify the disk . . . ” Column 6, lines 29-31.

An additional CD identification technique is disclosed in Scherf, et al., U.S. Pat. No. 6,061,680 (hereinafter “Scherf”). Specifically, Scherf discloses a CD identifier which is directly based on a combination of the number of tracks on the CD and the lengths of each track. For example, a concatenation of the lengths of each track (e.g., expressed in 1/75^{th} of a second) may be used to generate a “hexcode” for each CD.

Once the CD identification code is generated, both Yankowski and Scherf describe using the code to perform a lookup in a CD database and download CD-related information from the database. The CD-related information may include, for example, CD title and track information, supplemental multimedia content (e.g., video of the CD artist), and CD musical scores.

Several problems exist with the identification techniques disclosed in Yankowski not Scherf. In particular, given the vast number of CDs to be identified, these techniques result in numerous duplicate CD identification codes and, in some cases, multiple identification codes for the same CD. For example, an analysis of the “Free DB” CD database, which uses hexcodes to identify CDs, reveals 37,814 records having the same hexcode ID and 13,922 CDs having two or more ID mappings out of 364,477 total records (FreeDB July 2001 release, http://www.freedb.org). For the purpose of illustration, three Free DB records having the same hexcode are illustrated in FIG. 1.

A related problem with the foregoing CD identification techniques is that they are not extensible. Thus, as the CD database continues to grow, new CDs will create even more additional, ambiguous database records.

Accordingly, what is needed is an improved system and method for identifying media such as CDs and DVDs. What is also needed is a media identification technique which will uniquely identify both new and old CDs and DVDs.

### SUMMARY

A system and method for identifying CDs is described. In one embodiment, the track offsets stored on the CD are used to perform a database lookup. A hash function such as an MD5 hash may be applied to the track offsets to generate an identification code. In the event that another CD has the same set of track offsets, an extension code may be generated using one or more secondary identification techniques. One identification technique which may be employed is an identification code generated based on a spectral analysis of the audio content stored on a portion of the CD. The identification code based on the spectral analysis may be used as either a primary identification code or a secondary identification code (i.e., the extension code).

### BRIEF DESCRIPTION OF THE DRAWINGS

A better understanding of the present invention can be obtained from the following detailed description in conjunction with the following drawings, in which:

FIG. 1 illustrates duplicate database entries which result from prior art CD identification schemes.

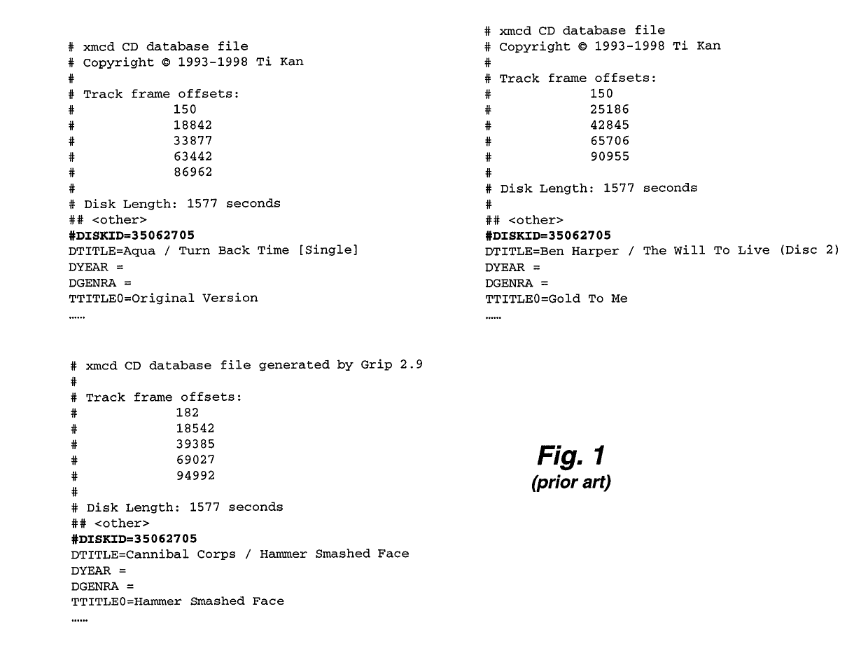

FIG. 2 illustrates a system for performing a database lookup using CD track offsets.

FIG. 3 illustrates a system for performing a database lookup using a hash of CD track offsets.

FIG. 4 illustrate a method for identifying a CD according to one embodiment of the invention.

FIG. 5 illustrates a system for generating an identification code extension according to one embodiment of the invention.

FIG. 6 illustrates one embodiment of an extension generation module for generating an ID code extension.

FIG. 7 illustrates the manner in which one embodiment of the invention selects a frame of multimedia content on which to perform an analysis.

FIG. 8 illustrates a matrix of frequency coefficients generated according to one embodiment of the invention.

FIG. 9 illustrates one embodiment in which frequency coefficients from selected columns are combined to generate a plurality of column identification values.

FIG. 10 illustrates a plurality of base identification codes and extension codes according to one embodiment of the invention.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

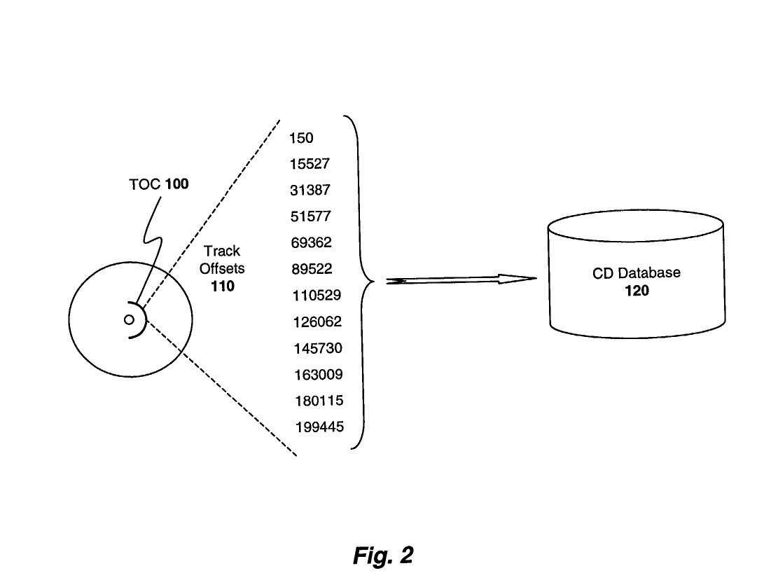

In one embodiment of the invention, the identification code used to identify the CDs or DVDs is comprised of all of the CD/DVD track offsets (or a subset thereof). The remainder of this detailed description will simply refer to “CDs” rather than “CDs and DVDs.” However, it will be appreciated that the underlying principles of the invention may be implemented with both DVDs and CDs. As illustrated in FIG. 2, the table of contents (“TOC”) 100 for each CD contains a set of offsets 110 which indicate the start point for each track on the CD (e.g., measured in increments of 1/75^{th} of a second). The specific track offsets 110 shown in FIG. 2 are 150, 15527, 31387, 51577, 69362, 89522, 110529, 126062, 145730, 163009, 180115, and 199445. In one embodiment, the track offset of the “leadout” track is included in the list of track offsets (e.g., the offset where the last track ends). Moreover, various levels of granularity may be employed. For example, the offsets listed above represent the number of 1/75^{th} of a second intervals. Alternatively, or in addition, a “second” level of granularity may be employed to capture some of the cases where there are variations in track offsets on different pressings of a CD. For example, in one embodiment, the offsets are measured to the nearest second.

Track offsets identify the CD from which they are read far more precisely than do the hexcode IDs employed by the “Free DB” system (and described in Scherf). For example, if the Free DB identification system used 1/75^{th} second track offsets rather than hexcodes, over 25,000 more unique records would result.

Once read from the CD, the track offsets 110 may then be used to query a database containing various types of CD-related information including, but not limited to CD titles and track titles. For example, in one embodiment of the invention, when a user adds a new CD to his/her system (e.g., by copying the content from the CD to a local mass storage device or by adding the CD to a CD changer), the CD-related information may be downloaded and stored locally. Subsequently, the user may identify the CD by the stored CD title and may select specific tracks within the CD by accessing the stored track titles. Various other CD-related information may be downloaded and stored consistent with the underlying principles of the invention.

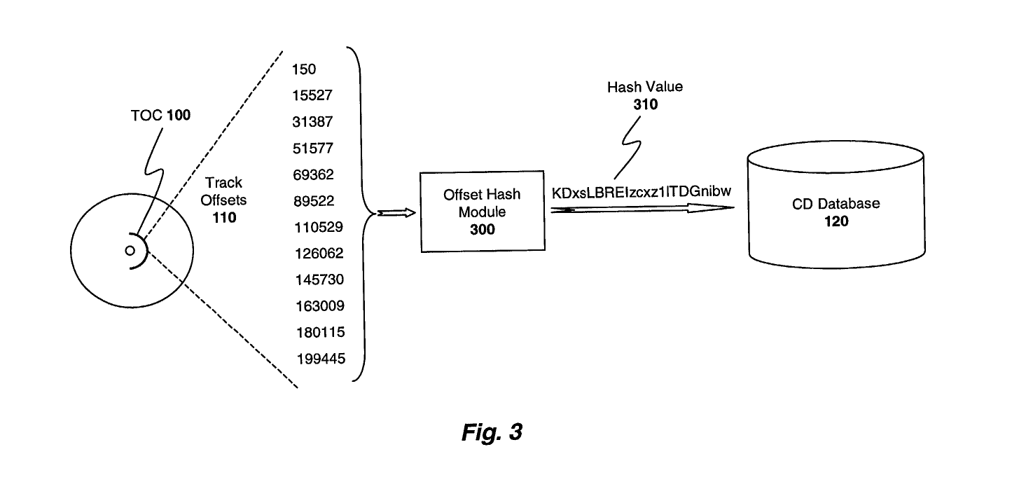

In one embodiment, the raw track offsets 110 may be converted into a more convenient format before being transmitted to the database 120. For example, as illustrated in FIG. 3, in one embodiment, an offset hash module 300 applies a hash function to generate a fixed-length hash value 310 representing the track offset values 110. In one particular embodiment, the hash function applied is an Message Digest 5 (“MD5”) hash. MD5 is a popular one-way hash function used to create a message digest for digital signatures. However, various alternative hash functions may be applied consistent with the underlying principles of the invention (e.g., SHA-1, MD4 . . . etc).

In one specific implementation, the MD5 hash is rendered in a 128-bit, Base-64 format. Base-64 is an encoding method that converts binary data into ASCII text (and vice versa). Specifically, Base-64 divides every three bytes of the original data into four 6-bit units, which it represents as four 7-bit ASCII characters.

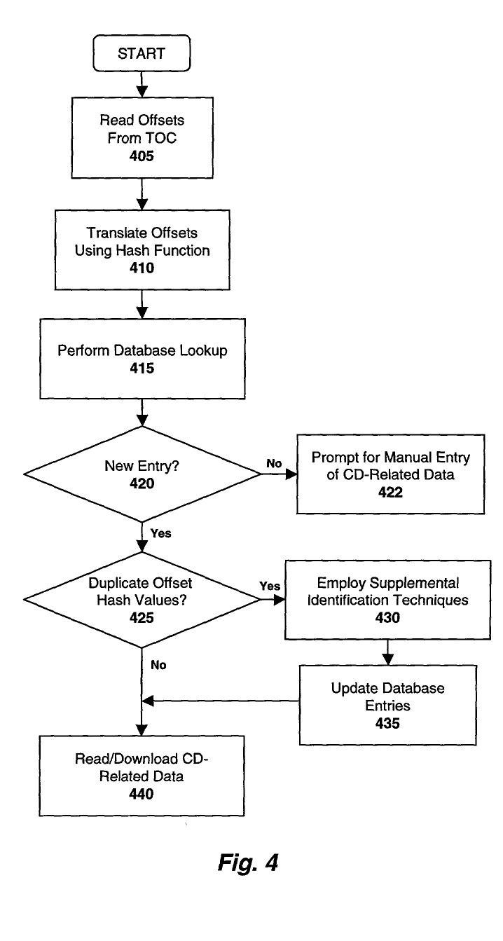

One embodiment of a method for identifying CDs is set forth in the flowchart in FIG. 4. At 405, track offsets are read from the TOC portion of the CD. At 410, the track offsets are translated using a particular hash function (e.g., MD5). At 415, the translated offset hash value is used to identify the CD in a database and, in response, CD-related data is accessed as described above. The database may be a remote database (e.g., located on an Internet server) or a local database (e.g., located on a local mass storage device). In one embodiment, a local database contains a subset of the data stored in the remote database (e.g., only those records associated with CDs owned by the user). When the user purchases a new CD, a new record may be created in the local database using data downloaded from the remote database.

At 420, a determination is made as to whether an entry for the CD already exists in the database. If not then, at 422, the user may be prompted to manually enter the CD title the track titles and/or other CD-related data. Once this information is entered, the database is updated with the new record and the new offset hash value. As such, when another user purchases the CD, the CD-related information will be readily available to be downloaded.

At 425, one embodiment of the system determines whether duplicate offset hash values exist for the record. In other words, in some rare cases, two or more CDs may have the same exact set of track offsets and, accordingly, the same offset hash value. For example, CD-related data for two CDs with the same offset hash value may already be stored in the database and/or a new CD may have the same hash value as one or more CDs already stored in the database. In either case, if duplicate entries exist, one or more supplemental identification techniques may be employed to identify the new CD more precisely. In one embodiment (described in detail below), an extension to the offset hash value is generated by performing an analysis of the multimedia content stored on the CD.

Once the supplemental identification techniques have been implemented, the supplemental identification data is saved to the database at 435. Consequently, the next time a user enters one of the CDs having the same offsets, the supplemental identification techniques may be initiated automatically to identify the CD entered by the user.

If only one database entry exists having the same offset hash value as the new CD, the user may be required to manually instruct the database that the CD-related data downloaded for that CD is inaccurate (i.e., the database may initially identify CD-related information for the wrong CD). The user may then be prompted to manually enter the CD-related data. Once the user does so, however, the supplemental identification techniques will be employed so that future users will not be required to manually enter the data. At 440, the CD-related data is stored locally (i.e., where the CD multimedia content resides).

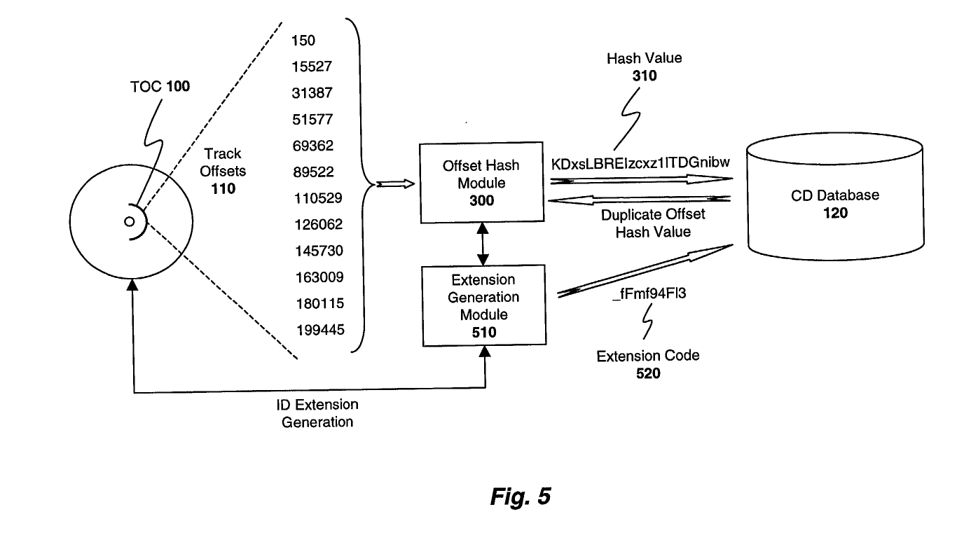

The supplemental identification techniques employed in one embodiment of the invention will now be described with respect to FIGS. 5-8. Although described herein as “supplemental,” it should be noted that these techniques may be employed as the primary identification mechanism for identifying CDs and other types of digital media. That is, in one embodiment, the offset hash value may not be used at all in the identification scheme.

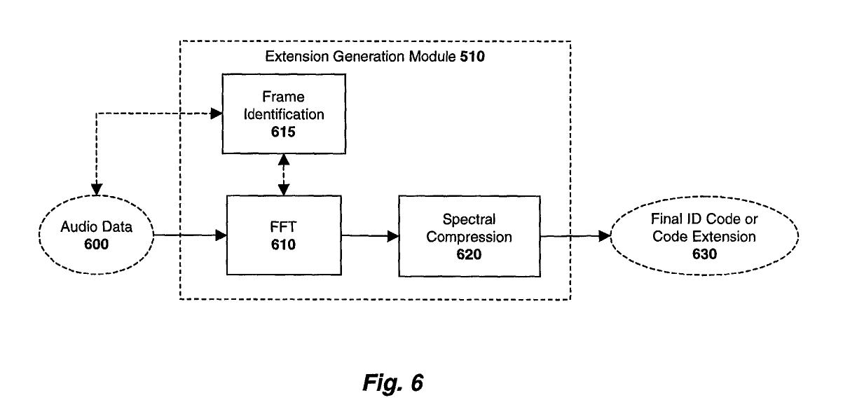

As illustrated in FIG. 5, in one embodiment, once a duplicate offset hash value has been identified in the database 120, an extension generation module 510 generates a unique extension code 520 based on a spectral analysis of the audio content stored on the CD (or other digital storage media). One specific embodiment of the extension generation module 510, illustrated in FIG. 6, is comprised of frame identification logic 615, a fast-Fourier transform module 610 and spectral compression logic 620.

Frame Identification

The frame identification logic 615 identifies an appropriate portion of the multimedia content to be analyzed. The portion of the multimedia content identified as “appropriate” may be based on a variety of factors including, but not limited to, the average energy of the multimedia content over a specified period of time (e.g., signal-to-noise ratio of the content). For example, referring to FIG. 6, in one embodiment, the frame identification logic 615 specifies an initial test point 701 from which to begin measuring the energy of the signal. The initial test point 701 may be selected randomly (e.g., within any track on the CD) or non-randomly (e.g., starting from the beginning of track one) while still complying with the underlying principles of the invention. In one embodiment, the test point 701 is selected at a point where the amplitude of the signal rises above some predetermined threshold.

Once the test point 701 is selected, in one embodiment, the frame identification logic 615 calculates the average energy of the audio/video signal over a predetermined period of time t₁ (e.g., ¼ sec) starting from the test point 701. If the average energy of the signal over that period of time is above a predefined minimum value Eₘᵢₙ, then the test point 701 and associated period (which ends at point 702) are rejected. In one embodiment, a moving average of the signal energy is calculated from the start point 701 onward. If the moving average drops below a threshold value, then a new test point 703 may be selected.

In one embodiment, points within the signal are measured using a relatively large step size. For example, the energy of the signal at every 1000 samples may initially be tested. If the energy at these points meets the predefined minimum criterion, then the test point 701 may be accepted. Alternatively, or in addition, the step size may be reduced (e.g., to 500 samples) and the measurements performed again.

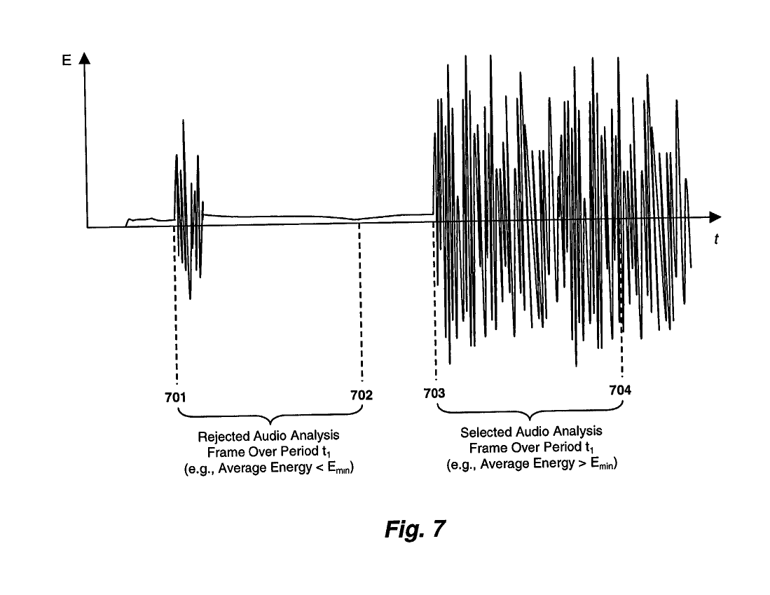

If the first test point 701 is rejected, a new test point 704 may be selected using a variety of techniques. For example, in one embodiment, the frame identification logic 615 jumps ahead a specific number of samples or a specific period of time, either from the end of the rejected audio analysis frame (e.g., point 703) or from the initial test point 702. Alternatively, in one embodiment, the new test point 704 may be selected randomly, either within a specific track (e.g., track 1) or at any point within the CD. Once the new test point 704 is selected, the same types of energy measurements may be initiated. If the minimum signal energy criteria are met, then the test point 704 is accepted and the audio analysis frame is identified (e.g., as the period of time defined by points 704 and 705 in FIG. 7). If the test point is rejected a second time, the frame identification logic 615 may select another test point as described above. In one embodiment, after a predetermined number of points are rejected within a particular track, the frame identification logic 615 may attempt to locate an acceptable point within a different track.

Spectral Analysis

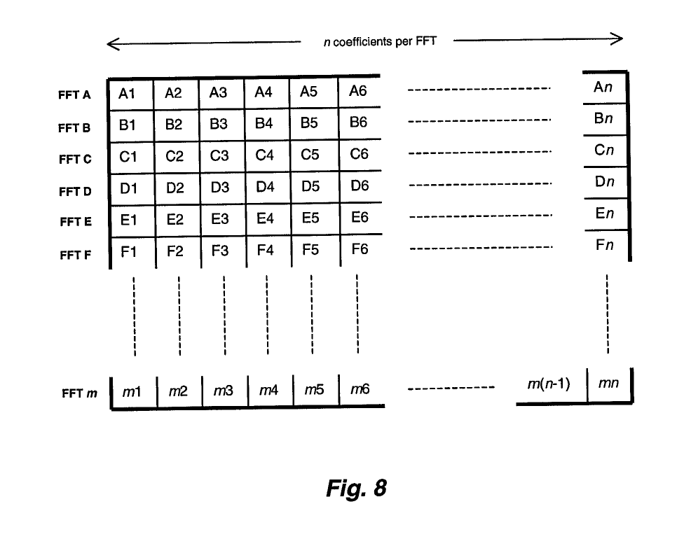

Once a start point and/or audio frame is identified, in one embodiment, a fast-Fourier transform (“FFT”) module performs a series of FFT operations on the audio/video signal to generate a series of frequency coefficients representing the signal in the frequency domain. As illustrated in FIG. 8, the series of FFT operations may be represented as a matrix. Each of the m rows of the matrix comprises a single FFT operation, identified as FFT ‘A’ through FFT m, and each FFT operation results in n frequency coefficients spread across the n matrix columns. In one embodiment, the FFT operations are performed on sequential portions of the signal across the audio analysis frame (i.e., from the start point 704 to the end point 705 in FIG. 7. Once all FFT operations are completed, the resulting frequency coefficients define the signal's frequency spectrum within the designated audio analysis frame.

In one embodiment, the FFT operations are 32-point FFT operations. Moreover, in one embodiment, a total of 32 32-point FFT operations are executed (i.e., resulting in a 32×32 matrix of frequency coefficients). However, it should be noted that various different types and numbers of FFT operations may be executed while still complying with the underlying principles of the invention.

The matrix itself may be used to identify the CD (or other digital media) from which it was read or, alternatively, the matrix may be converted/ compressed using a variety of additional encoding techniques. If the matrix itself is used, when a user inserts a new CD into his/her CD drive, the FFT operations described above may be re-executed from the start point 703 to reconstruct the matrix on-the-fly. The reconstructed matrix may then be used to identify the entry corresponding to the CD in the database 120, either alone or in combination with the offsets hash value (or other base identifier). The matrix stored in the database may not be exactly the same as the reconstructed matrix for a variety of reasons including, but not limited to, imperfections in the CD and inconsistencies in the CD production process. As such, a fuzzy comparison algorithm may be implemented to identify the entry in the database which most closely resembles the reconstructed matrix.

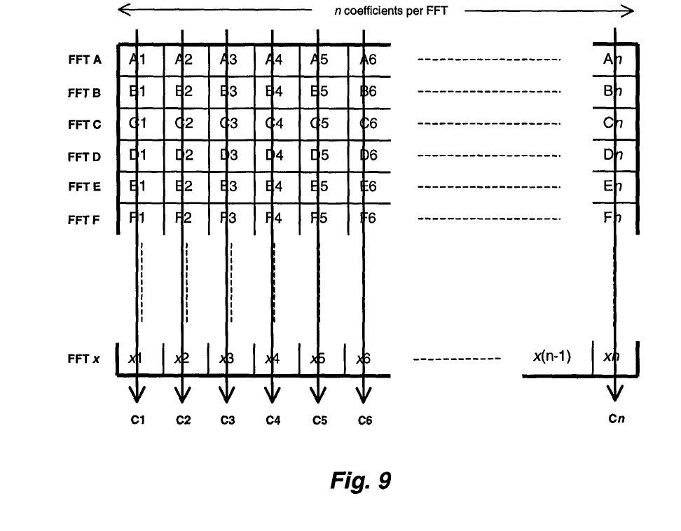

In one embodiment the matrix may be converted to a more convenient and potentially more precise identification code. The spectral compression module 620 shown in FIG. 6 may select the entire matrix or specific portions of the matrix to be converted. For example, as illustrated in FIG. 9, one or more of the matrix columns may be individually encoded to generate a single code value, C1 through Cn, associated with each column. If the columns are convolutionally encoded in this manner, the code value for each column represents the relative distribution of the specified frequency value over time (i.e., each column represents a particular frequency).

Once generated, one or more of the column codes, C1-Cn, may be combined and used as the CD identification code 630 (or the extension code if a different base code is used). The column codes may be combined in a variety of ways. In one embodiment, they are simply concatenated together to generate the final code. In another embodiment, the column codes may themselves be encoded using additional techniques. For example, in one embodiment, the spectral compression module 620 convolutionally encodes the column codes C1-Cn to arrive at the final ID code 630. Alternatively, the spectral compression module 620 may run the column codes through another hash function. The underlying principles of the invention remain the same regardless of how the final ID code 630 is generated.

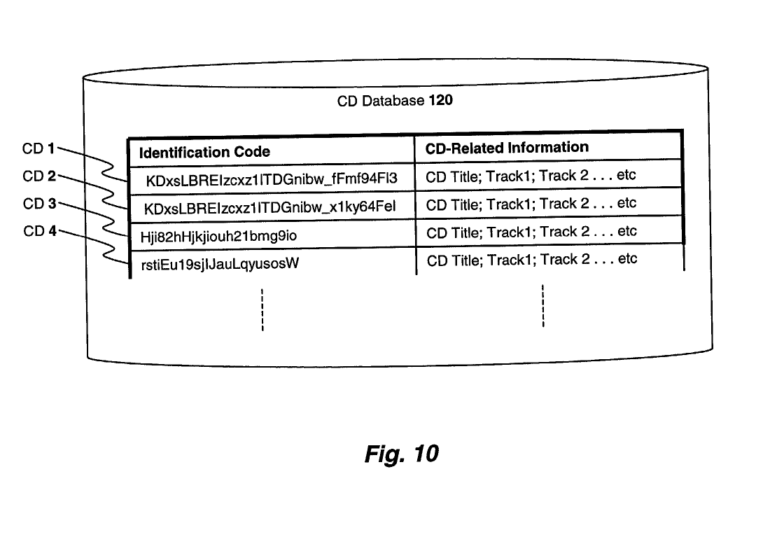

If the final ID code 630 is an extension to a base code (e.g., such as the offset hash value 310 described above) then it may be appended to the base code to generate the database entry for the CD. For example, as illustrated in FIG. 10, the database entries for CD1 and CD2 have the same base code (KDxsLBRElzcxz1ITDGnibw) but different extension codes (fFmf94FI3 and x1ky64Fel, respectively), which are needed to distinguish between the two CDs. By contrast, CD3 and CD4 have only a single offset hash value. No extension is required for these two CDs because there are no other entries with the same offset hash value.

In one particular embodiment, the CD identification techniques described herein may be employed on the CD storage and playback system and/or the CD transfer apparatus described in co-pending application entitled MULTIMEDIA TRANSFER SYSTEM filed Nov. 20, 2000 (Ser. No. 09/717,458) which is assigned to the assignee of the present application and which is incorporated herein by reference. For example, as CDs are copied (i.e., “ripped”) from the transfer apparatus to the user's storage and playback system, the CDs may be identified in a CD database stored on the transfer apparatus, the storage and playback system and/or a remote server communicatively coupled to a network (e.g., the Internet).

Embodiments of the invention may include various steps, which have been described above. The steps may be embodied in machine-executable program code which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although embodiments described above employ a two-tier identification code comprised of a base and (potentially) an extension, the underlying principles of the invention may be implemented using a single identification code. For example, either the spectral analysis code or the offset hash code described above may be used alone as the primary CD identifier. Accordingly, the scope and spirit of the invention should be judged in terms of the claims which follow.

What is claimed is:

1. A method comprising:
reading one or more track offsets from a compact disk (“CD”); and
performing a database lookup using said offsets to identify information associated with said CD in said database (“CD-related information”).

2. The method as in claim 1 further comprising:
encoding said offsets into an identification code; and
performing said database lookup using said identification code.

3. The method as in claim 2 wherein encoding comprises:
executing a hash algorithm to generate said identification code.

4. The method as in claim 3 wherein said hash algorithm is an MD5 hash algorithm.

5. The method as in claim 4 wherein said MD5 hash is rendered in a Base-64 format.

6. The method as in claim 1 wherein said CD-related information comprises CD titles and CD track titles.

7. The method as in claim 1 further comprising:
if two or more CDs have the same track offsets, employing one or more supplemental identification techniques to distinguish said two or more CDs in said database.

8. The method as in claim 7 wherein one of said supplemental identification techniques comprises:
performing an analysis of audio content stored on said CDs.

9. The method as in claim 8 wherein performing said analysis comprises:
identifying an audio analysis frame within which said audio content will be analyzed; and
transforming said audio content into a spectral representation of said audio content, said spectral representation usable to distinguish said two or more CDs having the same track offsets.

10. The method as in claim 9 wherein transforming further comprises:
performing one or more fast-Fourier transforms on said audio content within said audio analysis frame to obtain said spectral representation as a matrix of frequency coefficients.

11. The method as in claim 10 further comprising:
convolutionally encoding one or more columns of said matrix to generate convolutional codes representing each of said columns.

12. The method as in claim 11 further comprising:
encoding said convolutional codes to produce a single code representing said matrix.

13. The method as in claim 12 wherein encoding comprises:
performing a hash of said convolutional codes.

14. The method as in claim 12 wherein encoding comprises:
convolutionally encoding said convolutional codes.

15. A method for identifying media comprising:
identifying a multimedia analysis frame comprised of multimedia content within said media;
transforming said multimedia content into a spectral representation of said multimedia content; and
using said spectral representation to uniquely identify said media within a database.

16. The method as in claim 15 wherein identifying said multimedia analysis frame comprises:
measuring average energy of multimedia content within one or more test frames; and
identifying a test frame as said multimedia analysis frame if average energy within said test frame is above a threshold value.

17. The method as in claim 16 further comprising:
identifying a start point for said test frame based on energy of said multimedia content at said start point.

18. The method as in claim 15 wherein transforming comprises:
converting said multimedia content into a plurality of frequency coefficients.

19. The method as in claim 18 wherein converting comprises:
performing one or more fast-Fourier transforms on said multimedia content within said multimedia analysis frame to obtain a matrix of frequency coefficients.

20. The method as in claim 19 further comprising:
convolutionally encoding one or more columns of said matrix to generate convolutional codes representing each of said columns.

21. The method as in claim 20 further comprising:
encoding said convolutional codes to produce a single code representing said matrix.

22. The method as in claim 20 wherein encoding comprises:
performing a hash of said convolutional codes.

23. The method as in claim 15 wherein said multimedia content comprises audio content.

24. The method as in claim 23 wherein said media is a compact disk.

25. A method for identifying compact disks (“CDs”) comprising:
generating a first identification code based on data stored on a first CD;
attempting to perform a database lookup in a CD database using said first identification code; and
employing a second identification technique if said first identification code is a duplicate of an identification code used to identify a second CD in said database.

26. The method as in claim 25 wherein said first identification code is based on data stored in a table of contents (“TOC”) of said first CD.

27. The method as in claim 26 wherein said data are track offsets for said CD.

28. The method as in claim 25 wherein generating a first identification code comprises:
performing a hash of said track offsets to generate an offset hash value.

29. The method as in claim 28 wherein said hash comprises an MD5 hash.

30. The method as in claim 29 wherein said offset hash value is rendered in base-64 format.

31. The method as in claim 25 wherein said second identification technique comprises an analysis of a frame of audio content stored on said first CD.

32. The method as in claim 31 wherein said analysis comprises transforming said frame of audio content into its spectral components.

33. The method as in claim 32 wherein transforming comprises:
performing one or more fast-Fourier transforms on said frame of audio content to produce a matrix of frequency coefficients.

34. The method as in claim 33 further comprising:
transforming said matrix into a single value representing said matrix.
